(19) United States
(12) Patent Application Publication
(10) Pub. No.: US 2025/0172687 A1
(43) Pub. Date: May 29, 2025

(54) HIGHLY RELIABLE AND HIGH-PRECISION NAVIGATION AND POSITIONING METHOD AND SYSTEM FOR UAV UNDER GPS-DENIED CONDITIONS

(71) Applicant: SHENZHEN UNIVERSITY, Shenzhen, Guangdong (CN)

(72) Inventors: Jianqiang LI, Shenzhen (CN); Qingquan LI, Shenzhen (CN); Zun LIU, Shenzhen (CN); Jin ZHOU, Shenzhen (CN)

(73) Assignee: SHENZHEN UNIVERSITY, Shenzhen, Guangdong (CN)

(21) Appl. No.: 18/730,380

(22) PCT Filed: Jul. 12, 2022
(86) PCT No.: PCT/CN2022/105069

§ 371 Date: Jul. 19, 2024

(30) Foreign Application Priority Data
Jan. 21, 2022 (CN) 202210069955.7

(51) Int. Cl. G01S 13/86; B64C 39/02; G08G 5/50

(52) U.S. Cl. CPC G01S 13/867; B64C 39/024; G08G 5/50

(57) ABSTRACT

A highly reliable and high-precision navigation and positioning method and system for UAV under GPS-DENIED conditions includes: obtaining measurements of inertial sensor and image of binocular camera, extracting and tracking point features of the image, and obtaining altitude value; calculating position and attitude of camera and depth of landmark point based on the parallax and baseline of the binocular camera; fusing the measurement data of the inertial sensor and the binocular camera, and optimizing the data to obtain high-precision position and attitude data; obtaining the altitude value of the ranging radar and performing four-degree-of-freedom position and attitude graph optimization after adding the detected keyframes when repeated occurrence of the UAV at the same location is detected; encapsulating optimized position and attitude data to form a pseudo-GPS signal, inputting the pseudo-GPS signal to the UAV for positioning.

### TECHNICAL FIELD

The present disclosure relates to the technical field of navigating and positioning UAV under GPS-DENIED conditions, in particular relates to a highly reliable and high-precision navigation and positioning method and system for UAV under GPS-DENIED conditions, a UAV and a computer-readable storage medium.

### BACKGROUND

With the continuous development and maturity of UAV (unmanned aerial vehicle) technology, UAVs are widely used in aerial photography, agriculture, plant protection, express transportation, disaster rescue, wildlife observation, epidemic monitoring, surveying, news reporting, power inspection, disaster relief, film shooting, and other fields. However, the over-reliance on GPS signals hinders further application in the above scenarios. For example, in environment where signals are blocked by high-rise buildings, or in indoor environment, the positioning accuracy of GPS may reduce, and the UAV may not receive GPS signals, which make the UAVs unable to achieve autonomous flight and complete designated flight task, and even experience crashes or injuries to personnel. Thus, the development of positioning method in the context of GPS signal scarcity is urgent and has broad prospects for use.

As a supplemental positioning method in scenarios where GPS signals are lacking, SLAM (simultaneous localization and mapping) technology is widely used in fields such as robotics, UAV, autonomous driving, AR, and VR. By relying on sensors, it enables functions like autonomous positioning, mapping, and path planning for machines. Depending on the sensor type, the implementation of SLAM varies. SLAM can be primarily divided into two categories based on the sensors used: LiDAR SLAM and Visual SLAM. LiDAR SLAM began earlier than Visual SLAM and is relatively mature in terms of theory, technology, and product deployment. As early as 2005, LiDAR SLAM had been extensively studied, and its theoretical framework had been initially established. Currently, LiDAR SLAM is the most stable and mainstream method for positioning and navigation. However, LiDAR SLAM is relatively costly, with prices ranging from tens of thousands to hundreds of thousands of yuan. Additionally, the size and weight of LiDAR systems are significant, making them unsuitable for more flexible and lightweight terminals, and they can also affect aesthetics and performance. On the other hand, Visual SLAM solutions are currently in a phase of rapid development and expansion of application scenarios, with products gradually being deployed and having a very promising development prospect. Due to the used less expensive visual sensors, Visual SLAM shows relatively low cost, and is easy to be installed due to the small size. Visual SLAM can operate in both indoor and outdoor environments. The main disadvantages of Visual SLAM are the high dependence on the environment. For example, in low light, significant illumination changes, or environments with sparse textures and few feature points, feature tracking loss and positioning drift may be experienced. Additionally, Visual SLAM faces challenges such as easy loss of tracking during rapid motion, inability to measure scale with monocular vision, and difficulties in estimating pure rotation problems, all of which require further research and solutions.

Therefore, the prior art still needs improvements and enhancements.

### SUMMARY

The main purpose of the present disclosure is to provide a highly reliable and high-precision navigation and positioning method and a system for UAV under GPS-DENIED conditions, a UAV, and a computer-readable storage medium, aiming at solving the problems in the prior art that Visual SLAM shows localization drift in scenes with sparse textures and significant illumination changes, and scale is unable to be estimated by the monocular vision.

In order to achieve the above purpose, the present disclosure provides a highly reliable and high-precision navigation and positioning method for UAV under GPS-DENIED conditions, the highly reliable and high-precision navigation and positioning method for UAV under GPS-DENIED conditions includes steps of:
obtaining measurements of an inertial sensor and an image of a binocular camera, extracting and tracking point features of the image, and obtaining an altitude value measured by a ranging radar;
initializing the binocular camera, calculating a position and attitude of camera and a depth of landmark point based on a parallax and a baseline of the binocular camera;
fusing measurement data of the inertial sensor and the binocular camera, using sliding-window-based nonlinear graph optimization to obtain high-precision position and attitude data;
obtaining the altitude value of the ranging radar and performing four-degree-of-freedom position and attitude graph optimization after adding detected keyframes, when the loopback detection module detects a repeated occurrence of the UAV at a same location;
encapsulating the optimized position and attitude data to form a pseudo-GPS signal, inputting the pseudo-GPS signal to the UAV for positioning, performing route planning and setting landmark point tasks based on a current positioning.

Optionally, the highly reliable and high-precision navigation and positioning method for UAV under GPS-DENIED conditions also includes:
integrating the measurements collected by the inertial sensor to obtain position, attitude and velocity of the UAV, integration formula is as follow:

$$[ \begin{matrix}{α}_{{b}_{k + 1}}^{{b}_{k}} \\ {β}_{{b}_{k + 1}}^{{b}_{k}} \\ {γ}_{{b}_{k + 1}}^{{b}_{k}} \\ 0 \\ 0 \\ \end{matrix} ] = [ \begin{matrix}{R}_{w}^{{b}_{k}} ( {p}_{{b}_{k + 1}}^{w} - {p}_{{b}_{k}}^{w} + \frac{1}{2} {g}^{w} Δ {t}_{k}^{2} - {v}_{{b}_{k}}^{w} Δ {t}_{k} ) \\ {R}_{w}^{{b}_{k}} ( {v}_{{b}_{k + 1}}^{w} + {g}^{w} Δ {t}_{k} - {v}_{{b}_{k}}^{w} ) \\ {q}_{{b}_{k}}^{{w}^{- 1}} ⊗ {q}_{{b}_{k + 1}}^{w} \\ {b}_{{a}_{{b}_{k + 1}}} - {b}_{{a}_{{b}_{k}}} \\ {b}_{{w}_{{b}_{k + 1}}} - {b}_{{w}_{{b}_{k}}} \\ \end{matrix} ] .$$

Among them, bₖ means the kth keyframe moment in IMU coordinate system, α_{b}_{ₖ₊₁}^{b}^{ₖ} indicates an amount of change in position between bₖ and bₖ₊₁ frame moment, β_{b}_{ₖ₊₁}^{b}^{ₖ} indicates an amount of change in velocity between bₖ and bₖ₊₁ frame moment, γ_{b}_{ₖ₊₁}^{b}^{ₖ} indicates an amount of change in attitude between bₖ and bₖ₊₁ frame moment, R_{w}^{b}^{ₖ} indicates a rotation from world coordinate system to the IMU coordinate system at bₖ frame moment, p_{b}_{ₖ₊₁}^{w} indicates a position of the world coordinate system at bₖ₊₁ frame moment, p_{b}_{ₖ}^{w} indicates a position of the world coordinate system at bₖ frame moment, g^{w} indicates an acceleration of gravity in the world coordinate system, Δtₖ indicates a time interval from bₖ frame moment to bₖ₊₁ frame moment, v_{b}_{ₖ}^{w} indicates a velocity in the world coordinate system at bₖ frame moment, v_{b}_{ₖ₊₁}^{w} indicates a velocity in the world coordinate system at bₖ₊₁ frame moment, q_{b}_{ₖ}^{w} indicates an attitude in the world coordinate system at bₖ frame moment, q_{b}_{ₖ₊₁}^{w} indicates an attitude in the world coordinate system at bₖ₊₁ frame moment,

$${b}_{{a}_{{b}_{k + 1}}}$$

indicates a bias of IMU accelerometer at bₖ₊₁ frame moment,

$${b}_{{a}_{{b}_{k}}}$$

indicates a bias of IMU accelerometer at bₖ frame moment,

$${b}_{{w}_{{b}_{k + 1}}}$$

indicates a bias of IMU gyroscope at bₖ₊₁ frame moment, and

$${b}_{{w}_{{b}_{k}}}$$

indicates a bias of IMU gyroscope at bₖ frame moment.

Optionally, the highly reliable and high-precision navigation and positioning method for UAV under GPS-DENIED conditions also comprises:
obtaining state variables in the sliding-window, the state variables includes: position of the IMU coordinate system, velocity, attitude, accelerometer bias, gyroscope bias, external parameter from binocular camera to IMU, and inverse depths of m+1 3D landmark points during n+1 keyframe moment within the slide-window;

The state variables to be solved are expressed as follow:

$$\begin{matrix}χ = [ {x}_{0} , {x}_{1} , … {x}_{n} , {λ}_{0} , {λ}_{1} , … {λ}_{m} ] \\ {x}_{k} = [ {p}_{{b}_{k}}^{w} , {v}_{{b}_{k}}^{w} , {q}_{{b}_{k}}^{w} , {b}_{a} , {b}_{g} ] , k ∈ [ 0 , n ] \\ {x}_{c}^{b} = [ {p}_{c}^{b} , {q}_{c}^{b} ]\end{matrix} .$$

Among them, X denotes a set of state variables to be optimized during n+1 keyframe moments and m+1 landmark points, xₖ denotes a set of position p_{b}_{ₖ}, velocity v_{b}_{ₖ}, attitude q_{b}_{ₖ}, bias bₐ of the IMU accelerometer and bias b_{g} of the IMU gyroscope in the world coordinate system at bₖ frame moment, x_{c}^{b} denotes a translation p_{c}^{b} and a rotation q_{c}^{b} from a camera coordinate system to the IMU coordinate system.

Optionally, the highly reliable and high-precision navigation and positioning method comprises:

The graph optimization cost function is shown as follow:

$${min}_{χ} \{ {‖ {r}_{p} - {H}_{p} χ ‖}^{2} + {\sum }_{k ∈ B} {‖ {r}_{B} ( {𝓏}_{{b}_{k + 1}}^{{b}_{k}} , χ ) ‖}_{{p}_{{b}_{k + 1}}^{{b}_{k}}}^{2} + {\sum }_{( f , j ) ∈ 𝒞} {‖ {r}_{C} ( {𝓏}_{f}^{{c}_{j}} , χ ) ‖}_{{p}_{f}^{{c}_{j}}}^{2} + {\sum }_{( l , v ) ∈ L} {‖ {r}_{L} ( {𝓏}_{l}^{{c}_{v}} , χ ) ‖}_{{p}_{l}^{{c}_{v}}}^{2} \} .$$

Among them, rₚ denotes a marginalized priori error, Hₚ denotes a Hessian matrix, B denotes a set of IMU measurements, z_{b}_{ₖ₊₁}^{b}^{ₖ} denotes measurements of IMU between bₖ and bₖ₊₁ frame moment, p_{b}_{ₖ₊₁}^{b}^{ₖ} denotes a position from bₖ to bₖ₊₁ frame moment, r_{B} denotes a errors in pre-integration, C denotes a set of point features, z_{f}^{c}^{ⱼ} denotes an observation value at fth point feature of cⱼth image, p_{f}^{c}^{ⱼ} denotes a position of fth point feature of cⱼth image, r_{c} denotes a reprojection error of point features, L denotes a set of line features, zₗ^{c}^{ᵥ} denotes an observation value at lth line feature of cᵥth image, pₗ^{c}^{ᵥ} denotes a position of lth line feature of cᵥth image, r_{L} denotes a reprojection error of line features.

Optionally, in the highly reliable and high-precision navigation and positioning method for UAV under GPS-DENIED conditions, the parallax of the binocular camera is the difference in orientation between the two cameras of the binocular camera observing the same target, and the angle between the two cameras as viewed from the photographed target indicates the parallax angle of the two cameras, and the line connecting the two cameras is the baseline.

Optionally, in the highly reliable and high-precision navigation and positioning method for UAV under GPS-DENIED conditions, the position and attitude of camera is used for UAV navigation, and the depth of landmark point is used to build a map of the environment.

Optionally, in the highly reliable and high-precision navigation and positioning method for UAV under GPS-DENIED conditions, the fusing the measurement data of the inertial sensor and the binocular camera specifically comprises:
fusing the position, attitude and velocity obtained by integration of the inertial sensor with the features extracted by the binocular camera and image features obtained by matching, obtaining optimized position, attitude and velocity.

In addition, in order to achieve the above purpose, the present disclosure also provides a highly reliable and high-precision navigation and positioning system for UAV under GPS-DENIED conditions, wherein, the highly reliable and high-precision navigation and positioning system for UAV under GPS-DENIED conditions comprises:
data obtaining module, used for obtaining measurements of the inertial sensor and an image of the binocular camera, extracting and tracking the point features of the image, and obtaining the altitude value measured by the ranging radar;
data calculating module, used for initializing the binocular camera, calculating the position and attitude of camera and the depth of the landmark point based on the parallax and baseline of the binocular camera;
fusing and optimal module, used for fusing the measurement data of the inertial sensor and the binocular camera, using sliding-window based nonlinear graph optimization to obtain high-precision position and attitude data;
optimal position and attitude module, used for obtaining the altitude value of the ranging radar and perform four-degree-of-freedom position and attitude graph optimization after adding the detected keyframes, when the loopback detection module detects a repeated occurrence of the UAV at the same location;
navigation and positioning module, used for encapsulating the optimized position and attitude data to form a pseudo-GPS signal, inputting the pseudo-GPS signal to the UAV for positioning, performing route planning and setting landmark point tasks based on the current positioning.

In addition, in order to achieve the above purpose, the present disclosure also provides a UAV, wherein, the UAV comprising: a memory, a processor and a program for highly reliable and high-precision navigation and positioning system for UAV under GPS-DENIED conditions stored on the memory and runnable on the processor, the highly reliable and high-precision navigation and positioning program under GPS-DENIED for UAV, when being executed by the processor, implements the steps of the highly reliable and high-precision navigation and positioning method for UAV under GPS-DENIED conditions.

In addition, in order to achieve the above purpose, the present disclosure also provides a computer-readable storage medium, wherein the computer-readable storage medium stores a highly reliable and high-precision navigation and positioning program under GPS-DENIED for UAV, the highly reliable and high-precision navigation and positioning program under GPS-DENIED for UAV being executed by a processor to implement the steps of the highly reliable and high-precision navigation and positioning method for UAV under GPS-DENIED conditions.

In the present disclosure, the measurements of the inertial sensor and the image of the binocular camera are obtained, point features of the image are extracted and tracked, and the altitude value measured by the ranging radar is acquired. The binocular camera is initialized to calculate position and attitude of camera and depth of landmark point based on the parallax and the baseline of the binocular camera. Then, the measurement data of the inertial sensor and the binocular camera are fused, and a high-precision position and attitude data is obtained using nonlinear graph optimization based on the sliding-window. When the loopback detection module detects that the UAV reappears at the same location, the altitude value of the ranging radar is obtained and the four-degree-of-freedom position and attitude graph optimization is performed after the detected keyframes are added. The optimized position and attitude data is then encapsulated to form a pseudo-GPS signal, and the pseudo-GPS signal is input into the UAV for positioning, and based on the current positioning, route planning and landmark point tasks are set. The present disclosure efficiently and accurately provides positioning signals for the UAV by fusing data from the inertial sensor and the stereo camera, greatly enhancing the safety and robustness of the UAV positioning system.

### BRIEF DESCRIPTION OF THE DRAWINGS

FIG. 1 shows a flow chart of an embodiment of a highly reliable and high-precision navigation and positioning method for UAV under GPS-DENIED conditions provided by the present disclosure;

FIG. 2 shows a flow chart of an embodiment of entire positioning execution step in a highly reliable and high-precision navigation and positioning method for UAV under GPS-DENIED conditions provided by the present disclosure;

FIG. 3 shows a tightly coupled visual-inertial graph optimization based on a sliding-window of an embodiment of a highly reliable and high-precision navigation and positioning method for UAV under GPS-DENIED conditions provided by the present disclosure;

FIG. 4 shows schematic diagram of the optimization of the position map for loopback detection of an embodiment of a highly reliable and high-precision navigation and positioning method for UAV under GPS-DENIED conditions provided by the present disclosure;

FIG. 5 shows a schematic diagram of a UAV flight trajectory of an embodiment of a highly reliable and high-precision navigation and positioning method for UAV under GPS-DENIED conditions provided by the present disclosure;

FIG. 6 shows a schematic diagram of a UAV flight trajectory based on point-line features of an embodiment of a highly reliable and high-precision navigation and positioning method for UAV under GPS-DENIED conditions provided by the present disclosure;

FIG. 7 shows a schematic diagram of the principle of an embodiment of a highly reliable and high-precision navigation and positioning system for UAV under GPS-DENIED conditions provided by the present disclosure;

FIG. 8 shows a schematic diagram of an operating environment of an embodiment of a UAV provided by the present disclosure;

### DETAILED DESCRIPTION OF EMBODIMENTS

In order to make the objects, technical solutions and effects of the present disclosure clearer and more explicit, the present disclosure is described in further detail hereinafter with reference to the accompanying drawings and embodiments. It should be understood that the specific embodiments described herein are only for explaining the present disclosure and are not intended to limit the present disclosure.

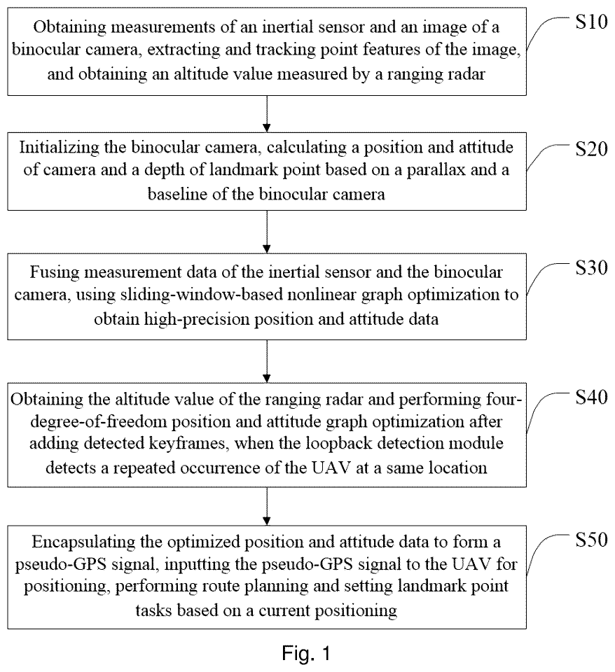

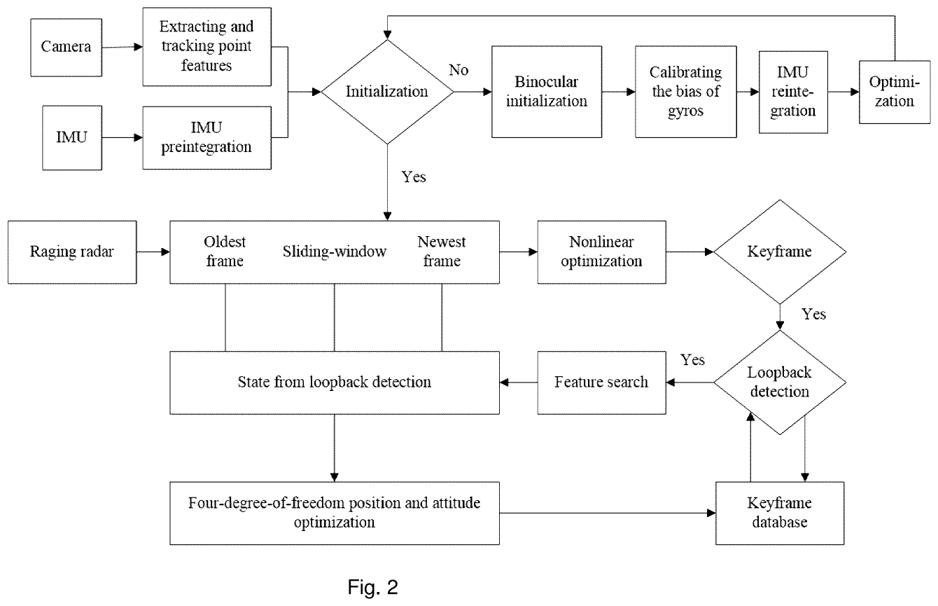

For the highly reliable and high-precision navigation and positioning method for UAV under GPS-DENIED conditions described in an embodiment of the present disclosure, as shown in FIG. 1 and FIG. 2, the highly reliable and high-precision navigation and positioning method for UAV under GPS-DENIED conditions includes the following steps:

Step 10, obtaining the measurements of the inertial sensor and the image of the binocular camera, extracting and tracking the point features of the image, and obtaining the altitude value measured by the ranging radar.

In the present embodiment, the hardware computing platform of the present disclosure is: NVIDIA AGX Xavier, 8-Core Carmel ARM, 512 Core Volta, 32 GB 256 bit LPDDR4x; IMU (Inertial Measurement Unit, inertial sensors, 200 HZ, mainly used to detect and measure the acceleration and rotational motion) measurements are obtained, and images of the binocular cameras (e.g. the depth camera is the Intel Realsense D455, with a depth field of view of 86°×57°(±3°)) are acquired. The IMU of the D455 is labeled and positioned using IMU_utils, and the internal references of the D455 binocular camera and the external references between the camera and the IMU are labeled and positioned using kalibr and Apriltag. The core problem of visual odometry is how to estimate camera motion from images. However, the image itself is a matrix composed of luminance and color, and it would be very difficult to consider motion estimation directly from the matrix level. Therefore, it is more convenient to extract and track the representative point features and line features from the image. The point features are tracked using Haris corner points with KLT optical flow, the line features are detected using a modified LSD (Line Segment Detector) algorithm, described by the LBD (Line Description Detector), and matched by KNN (K-Nearest Neighbor). And the IMU part uses the pre-integration technique, which integrates the measurements of multiple IMUs to get the position p, attitude q, and velocity v of the system as shown in Eq. 1. Also, the altitude value measured by the ranging radar is obtained.

That is to say, the plurality of measurements collected by the inertial sensor are integrated to obtain the position, attitude and velocity of the UAV, the integration formula is as follow:

$$[ \begin{matrix}{α}_{{b}_{k + 1}}^{{b}_{k}} \\ {β}_{{b}_{k + 1}}^{{b}_{k}} \\ {γ}_{{b}_{k + 1}}^{{b}_{k}} \\ 0 \\ 0 \\ \end{matrix} ] = [ \begin{matrix}{R}_{w}^{{b}_{k}} ( {p}_{{b}_{k + 1}}^{w} - {p}_{{b}_{k}}^{w} + \frac{1}{2} {g}^{w} Δ {t}_{k}^{2} - {v}_{{b}_{k}}^{w} Δ {t}_{k} ) \\ {R}_{w}^{{b}_{k}} ( {v}_{{b}_{k + 1}}^{w} + {g}^{w} Δ {t}_{k} - {v}_{{b}_{k}}^{w} ) \\ {q}_{{b}_{k}}^{{w}^{- 1}} ⊗ {q}_{{b}_{k + 1}}^{w} \\ {b}_{{a}_{{b}_{k + 1}}} - {b}_{{a}_{{b}_{k}}} \\ {b}_{{w}_{{b}_{k + 1}}} - {b}_{{w}_{{b}_{k}}} \\ \end{matrix} ] . \qquad ( Eq . 1 )$$

Among them, bₖ means the kth keyframe moment in IMU coordinate system, α_{b}_{ₖ₊₁}^{b}^{ₖ} indicates an amount of change in position between bₖ and bₖ₊₁ frame moment, β_{b}_{ₖ₊₁}^{b}^{ₖ} indicates an amount of change in velocity between bₖ and bₖ₊₁ frame moment, γ_{b}_{ₖ₊₁}^{b}^{ₖ} indicates an amount of change in attitude between bₖ and bₖ₊₁ frame moment, R_{w}^{b}^{ₖ} indicates a rotation from world coordinate system to the IMU coordinate system at bₖ frame moment, p_{b}_{ₖ₊₁}^{w} indicates a position of the world coordinate system at bₖ₊₁ frame moment, p_{b}_{ₖ}^{w} indicates a position of the world coordinate system at bₖ frame moment, g^{w} indicates an acceleration of gravity in the world coordinate system, Δtₖ indicates a time interval from bₖ frame moment to bₖ₊₁ frame moment, v_{b}_{ₖ}^{w} indicates a velocity in the world coordinate system at bₖ frame moment, v_{b}_{ₖ₊₁}^{w} indicates a velocity in the world coordinate system at bₖ₊₁ frame moment, q_{b}_{ₖ}^{w} indicates an attitude in the world coordinate system at bₖ frame moment, q_{b}_{ₖ₊₁}^{w} indicates an attitude in the world coordinate system at bₖ₊₁ frame moment,

$${b}_{{a}_{{b}_{k + 1}}}$$

indicates a bias of IMU accelerometer at bₖ₊₁ frame moment,

$${b}_{{a}_{{b}_{k}}}$$

indicates a bias of IMU accelerometer at bₖ frame moment,

$${b}_{{w}_{{b}_{k + 1}}}$$

indicates a bias of IMU gyroscope at bₖ₊₁ frame moment, and

$${b}_{{w}_{{b}_{k}}}$$

indicates a bias of IMU gyroscope at bₖ frame moment.

Step 20, initializing the binocular camera, calculating the position and attitude of camera and the depth of landmark point based on the parallax and baseline of the binocular camera.

In the present embodiment, firstly the binocular camera is initialized, the parallax exists in the binocular camera. The parallax is the difference in orientation while observing the same target from two points, such as two cameras, having a certain distance therebetween, the parallax angle between the two points is the angle while observing the two points from the target, and the baseline is the line connecting the two points. Once the parallax angle and the length of the baseline are obtained, the distance between the target and the observer can be calculated. Based on the parallax and the baseline of the binocular camera the position and attitude of camera and the landmark points, i.e., the depth of image features, can be calculated. Then the calculated position and attitude of camera can be utilized for UAV navigation and the depth of landmark points is adopted to build the map of the environment. Since the gyroscope can also integrate the camera's rotation, the bias of IMU can be calculated by the equation that the rotation calculated by the camera is equal to the rotation integrated by the IMU. Then the calculated bias is used to re-integrate the previous IMU data. Subsequently, the position and attitude calculated by the IMU and the camera are further optimized. Ultimately, a relatively accurate position and attitude of the UAV at the current moment is provided to be the initial value for the back-end nonlinear optimization.

The back-end of the present disclosure adopts a form of sliding-window to optimize the point features and line features together. The state variables in the sliding-window include the position of the IMU coordinate system, velocity, attitude (rotation), accelerometer bias, gyroscope bias, external parameter from Camera to IMU, and the inverse depths of m+1 3D roadmap points at the n+1 keyframe moment within the sliding-window, and the state variables to be solved are expressed as Eq. 2:

$$\begin{matrix}χ = [ {x}_{0} , {x}_{1} , … {x}_{n} , {λ}_{0} , {λ}_{1} , … {λ}_{m} ] \\ {x}_{k} = [ {p}_{{b}_{k}}^{w} , {v}_{{b}_{k}}^{w} , {q}_{{b}_{k}}^{w} , {b}_{a} , {b}_{g} ] , k ∈ [ 0 , n ] \\ {x}_{c}^{b} = [ {p}_{c}^{b} , {q}_{c}^{b} ]\end{matrix} . \qquad ( Eq . 2 )$$

Among them, X denotes a set of state variables to be optimized during n+1 keyframe moments and m+1 landmark points, xₖ denotes a set of position p_{b}_{ₖ}, velocity v_{b}_{ₖ}, attitude q_{b}_{ₖ}, bias bₐ of the IMU accelerometer and bias b_{g} of the IMU gyroscope in the world coordinate system at bₖ frame moment, x_{c}^{b} denotes a translation p_{c}^{b} and a rotation q_{c}^{b} from a camera coordinate system to the IMU coordinate system.

The graph optimization cost function is shown in Eq 3:

$${min}_{χ} \{ {‖ {r}_{p} - {H}_{p} χ ‖}^{2} + {\sum }_{k ∈ B} {‖ {r}_{B} ( {𝓏}_{{b}_{k + 1}}^{{b}_{k}} , χ ) ‖}_{{p}_{{b}_{k + 1}}^{{b}_{k}}}^{2} + {\sum }_{( f , j ) ∈ 𝒞} {‖ {r}_{C} ( {𝓏}_{f}^{{c}_{j}} , χ ) ‖}_{{p}_{f}^{{c}_{j}}}^{2} + {\sum }_{( l , v ) ∈ L} {‖ {r}_{L} ( {𝓏}_{l}^{{c}_{v}} , χ ) ‖}_{{p}_{l}^{{c}_{v}}}^{2} \} . \qquad ( Eq . 3 )$$

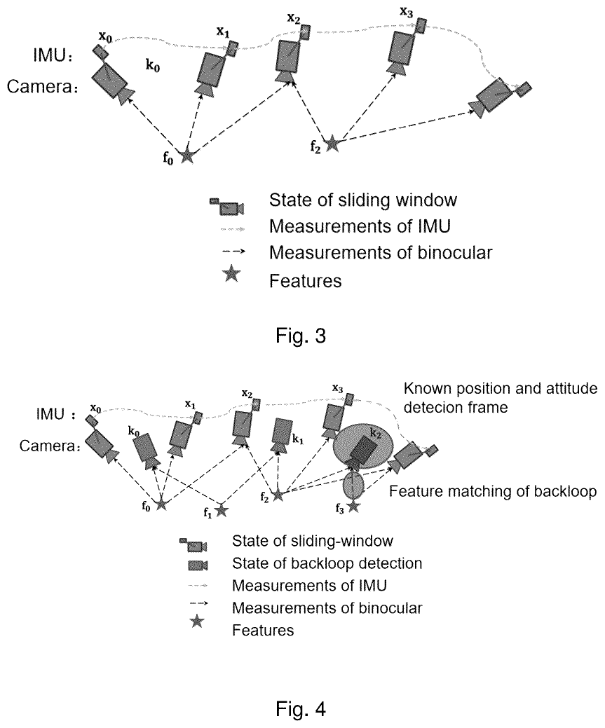

Among them, rₚ denotes a marginalized priori error, Hₚ denotes a Hessian matrix, B denotes a set of IMU measurements, z_{b}_{ₖ₊₁}^{b}^{ₖ} denotes measurements of IMU between bₖ and bₖ₊₁ frame moment, p_{b}_{ₖ₊₁}^{b}^{ₖ} denotes a position from bₖ to bₖ₊₁ frame moment, r_{B} denotes a errors in pre-integration, C denotes a set of point features, z_{f}^{c}^{ⱼ} denotes an observation value at fth point feature of cⱼth image, p_{f}^{c}^{ⱼ} denotes a position of fth point feature of cⱼth image, r_{c} denotes a reprojection error of point features, L denotes a set of line features, zₗ^{c}^{ᵥ} denotes an observation value at lth line feature of cᵥth image, pₗ^{c}^{ᵥ} denotes a position of lth line feature of cᵥth image, r_{L} denotes a reprojection error of line features. The structure of the graph optimization is illustrated in FIG. 3.

Step 30, fusing the measurement data of the inertial sensor and the binocular camera, using sliding-window-based nonlinear graph optimization to obtain high-precision position and attitude data.

Specifically, the front-end of the system adopts a tightly coupled method to fuse the optimized position, velocity, and attitude obtained from the integration of the IMU data with the image features extracted and matched by the binocular camera, to obtain the optimized position, velocity, and attitude. And the back-end adopts a sliding-window-based nonlinear graph optimization for further optimization to obtain the high-precision position and attitude data.

Step 40, obtaining the altitude value of the ranging radar and performing four-degree-of-freedom position and attitude graph optimization after adding the detected keyframes, when the loopback detection module detecting a repeated occurrence of the UAV at the same location.

Specifically, the loopback detection module performs loop detection with another thread utilizing a bag-of-words model with a BRIEF descriptor to detect if the UAV is reappeared at the same location. When a loop is detected, a connection needs to be established between the new keyframe and its loop candidate by means of the retrieved features. As shown in FIG. 4, once the repositioning is detected, the height data measured by the radar is firstly obtained, then the keyframes from the loopback detection are added to the graph optimization for the four-degree-of-freedom (x, y, z, yaw) position and attitude graph optimization. Because the data from the radar is more accurate, it is able to optimize the other three degrees of freedom when performing the global optimization to obtain results having high-precision positioning.

Step 50, encapsulating the optimized position and attitude data to form a pseudo-GPS signal, inputting the pseudo-GPS signal to the UAV for positioning, performing route planning and setting landmark point tasks based on the current positioning.

Specifically, the brainware (flight control) on the UAV encapsulates the position and attitude data output from the SLAM via the serial port to form a pseudo-GPS signal via the MavLink (Micro Air Vehicle Message Marshalling Library) protocol, and inputs the pseudo-GPS signal to the flight control to position the UAV. Based on the localization, corresponding route planning and landmark point tasks can be carried out.

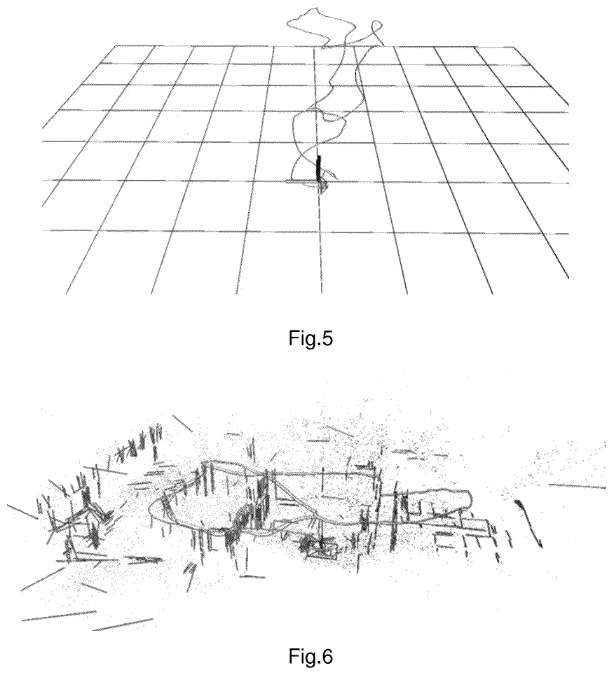

As shown in FIG. 5, the position output by SLAM is given to the flight control, which controls the UAV to return to the origin after flying a circle in the air. The trajectory diagram demonstrates that the take-off point and the landing point of the airplane are the same.

As shown in FIG. 6, the results of running the Euroc dataset based on the VINS algorithm with point and line features are shown. Compared with the VINS-FUSION with point features alone, the algorithm of the present disclosure can achieve a higher localization accuracy.

The present disclosure integrates the line features into the binocular-inertial SLAM, and at the same time the laser data for joint optimization is fused, which can effectively reduce the data error of other axes, and improve the localization accuracy of the system in scenes having sparse texture or large illumination changes. At the same time, a restart mechanism when SLAM fails is developed, which can greatly enhance the safety of UAV adopting SLAM for positioning.

Further, line features are added to the binocular camera to be fused into VINS, and other modules for altimetry are used to measure the height of the UAV from the ground, or in feasible scenarios multiple axes can be measured at the same time to jointly participate in the joint optimization of the position and attitude graph of UAV.

The technical effects achieved by the technical solution of the present disclosure are as follows:

(1) The measurement data of binocular camera and IMU are fused to form an efficient and high-precision position and attitude estimation algorithm: the data of IMU has the characteristic of sensitive response; the position, attitude and velocity calculated by long-term integration according to the angular velocity and acceleration obtained from IMU may be diverged, and the accuracy may be reduced, and there is a zero bias of IMU. A section of angular velocity data is collected in the stationary state, and under the ideal state, (aₓ, a_{y}, a_{z})=(0,0,0), but in reality the output of the gyroscope is a slowly varying curve of a complex white noise signal, and the average of the curve is the zero bias value.

Because of the existence of zero bias, the estimated position error will be enlarged. Therefore, the IMU is suitable for calculating short time and fast motion. The visual localization module adopts the binocular camera which has better static accuracy, but measurement dead zone and slow response exist, which is suitable for calculating long time and slow motion. The present disclosure adopts a novel framework of sensor fusion to process sensor fusion of IMU and binocular camera, taking the advantages of each to form an efficient and stable localization algorithm.

(2) The current mainstream SLAM algorithms are all completely based on point features, and the SLAM algorithms perform poorly in scenes having sparse textures or repeated textures. The present disclosure introduces a line feature mechanism that the SLAM front-end extracts the line features while extracting the point features. Because line features include more geometric information and are more robust regarding light changes, the accuracy of the SLAM algorithm can be greatly improved. At the same time, better back-end optimization methods are also adopted for multi-sensor fusion, for example, using a more high-precision laser ranging sensor to measure height, and then the height information in the z-axis is used to optimize the data in other axes.
(3) A unique safety mechanism is developed, taking into account the common failure problem of SLAM algorithms, the system can save the state variables before failure and initialize them quickly, and calculate the position change at the time of failure for compensation, so that the safety and robustness of the whole positioning system is greatly improved.

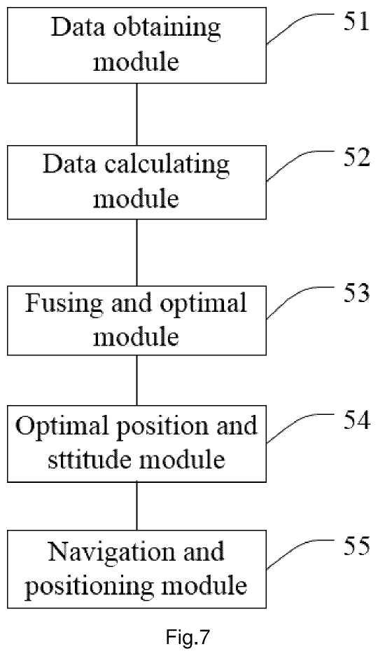

Further, as shown in FIG. 7, based on the above-described highly reliable and high-precision navigation and positioning method for UAV under GPS-DENIED conditions, the present disclosure also provides a highly reliable and high-precision navigation and positioning system for UAV under GPS-DENIED conditions, the highly reliable and high-precision navigation and positioning system for UAV under GPS-DENIED conditions includes:
data obtaining module 51, used for obtaining the measurements of the inertial sensor and an image of the binocular camera, extracting and tracking the point features of the image, and obtaining the altitude values measured by the ranging radar;
data calculating module 52, used for initializing the binocular camera, calculating the position and attitude of camera and the depth of the landmark point based on the parallax and baseline of the binocular camera;
fusing and optimal module 53, used for fusing the measurement data of the inertial sensor and the binocular camera, using sliding-window based nonlinear graph optimization to obtain high-precision position and attitude data;
optimal position and attitude module 54, used for obtaining the altitude value of the ranging radar and perform four-degree-of-freedom position and attitude graph optimization after adding the detected keyframes, when the loopback detection module detects a repeated occurrence of the UAV at the same location;
navigation and positioning module 55, used for encapsulating the optimized position and attitude data to form a pseudo-GPS signal, inputting the pseudo-GPS signal to the UAV for positioning, performing route planning and setting landmark point tasks based on the current positioning.

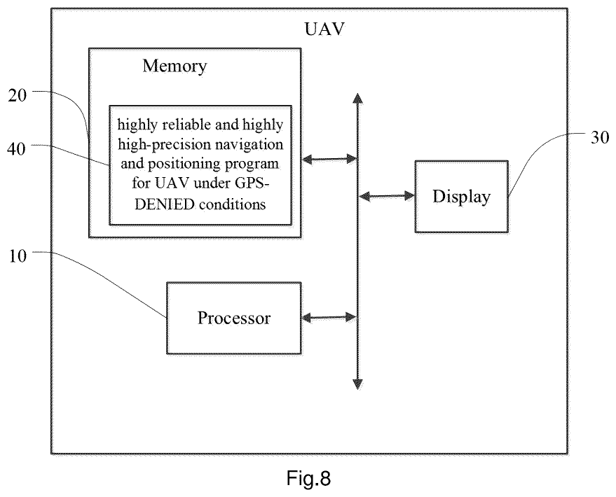

Further, as shown in FIG. 8, based on the above-described highly reliable and high-precision navigation and positioning method for UAV under GPS-DENIED conditions, the present disclosure also provides a UAV, the UAV includes a processor 10, a memory 20, and a display 30. FIG. 8 only illustrates some of the components of the UAV, but it should be understood that the implementation of all the illustrated components is not required, and more or fewer components may alternatively be implemented.

The memory 20 in some embodiments may be an internal storage unit of the UAV, such as a hard disk or memory of the UAV. The memory 20 in some other embodiments can also be an external storage device of the UAV, such as a plug-in hard disk equipped on the UAV, a SMC (Smart Media Card), a SD (Secure Digital) card, a Flash Card, etc. Further, the memory 20 may also include both an internal storage unit of the UAV and an external storage device. The memory 20 is used to store application software and various types of data installed in the UAV, such as program code for the installed UAV, etc. The memory 20 may also be used to temporarily store data that has been output or will be output. In an embodiment, a highly reliable and high-precision navigation and positioning program 40 for UAV under GPS-DENIED conditions is stored in the memory 20, and the program 40 can be executed by the processor 10, thereby implementing the high reliable and high precision navigation and positioning method for UAV under GPS-DENIED conditions in the present disclosure.

The processor 10 may in some embodiments be a CPU (Central Processing Unit), microprocessor or other data processing chip for running program code stored in the memory 20 or processing data, such as executing a highly reliable and high-precision navigation and positioning method for UAV under GPS-DENIED conditions.

The display 30 in some embodiments may be an LED display, an LCD display, a touchscreen LCD display, or an OLED (Organic Light-Emitting Diode) touchscreen, among others. The display 30 is used for displaying information in the UAV as well as for displaying a visual user interface. The components 10-30 of the UAV communicate with each other via a system bus.

In an embodiment, the processor 10 implements the steps of the highly reliable and high-precision navigation and positioning method for UAV under GPS-DENIED conditions when the highly reliable and high-precision navigation and positioning program 40 for UAV under GPS-DENIED conditions in the memory 20 is executed by the processor 10.

The present disclosure also provides a computer-readable storage medium. The computer-readable storage medium stores a highly reliable and high-precision navigation and positioning program for UAV under GPS-DENIED conditions, while the highly reliable and high-precision navigation and positioning program for UAV under GPS-DENIED conditions being executed by a processor, the steps of the highly reliable and high-precision navigation and positioning method for UAV under GPS-DENIED conditions as described above are implemented.

In summary, the present disclosure provides a highly reliable and high-precision navigation and positioning method and system for UAV under GPS-DENIED conditions, a UAV and a computer-readable storage medium. The method includes steps of: obtaining the measurements of the inertial sensor and the image of the binocular camera, extracting and tracking point features of the image, and obtaining the altitude value measured by the ranging radar; initializing the binocular camera, calculating position and attitude of camera and depth of landmark point based on the parallax and baseline of the binocular camera; fusing the measurement data of the inertial sensor and the binocular camera, using sliding-window-based nonlinear graph optimization to obtain high-precision position and attitude data; obtaining the altitude value of the ranging radar and performing four-degree-of-freedom position and attitude graph optimization after adding the detected keyframes, when the loopback detection module detects a repeated occurrence of the UAV at the same location; encapsulating the optimized position and attitude data to form a pseudo-GPS signal, inputting the pseudo-GPS signal to the UAV for positioning, performing route planning and setting landmark point tasks based on the current positioning. The present disclosure provides positioning signals efficiently and accurately by fusing the data from the inertial sensor and binocular camera, so that the safety and robustness of the UAV positioning system are greatly improved.

It should be noted that, as used herein, the terms “including”, “includes”, or any other variant thereof, are intended to encompass non-exclusive inclusion, such that a process, method, article, or UAV that comprises a set of elements not only comprises those elements, but also comprises other elements that are not explicitly listed or that are inherent to such process, method, article, or UAV. includes other elements that are not explicitly listed, or that are inherent to such process, method, article or UAV. Without further limitation, the fact that an element is defined by the phrase “includes a . . . ” does not preclude the existence of another identical element in the process, method, article or UAV that includes that element.

Of course, those skilled in the art may understand that all or part of the process of realizing the method of the above embodiments may be accomplished by a computer program to instruct the relevant hardware (e.g., a processor, a controller, etc.), and the program may be stored in a computer-readable storage medium, and the program may include the process of the above embodiments of the method in the execution thereof. The computer-readable storage medium may be a memory, a disk, a CD-ROM, and the like.

It should be understood that for those skilled in the art, equivalent substitutions or changes may be made in accordance with the technical solution of the present disclosure and its inventive conception, and all such changes or substitutions shall fall within the scope of protection of the claims appended to the present disclosure.

1-10. (canceled)

11. A navigation and positioning method for an unmanned aerial vehicle (UAV) under GPS-DENIED conditions, wherein the UAV comprises: an inertial sensor, a binocular camera, a ranging radar and a loopback detection module;
the method comprising:
obtaining measurements of the inertial sensor and an image of the binocular camera, extracting and tracking point features of the image, and obtaining an altitude value measured by the ranging radar;
initializing the binocular camera, and calculating a position and attitude of camera and a depth of landmark point based on a parallax and a baseline of the binocular camera;
fusing measurement data of the inertial sensor and the binocular camera, using sliding-window based nonlinear graph optimization to obtain high-precision position and attitude data;
obtaining the altitude value of the ranging radar and performing four-degree-of-freedom position and attitude graph optimization after adding detected keyframes when the loopback detection module detects a repeated occurrence of the UAV at a same location;
encapsulating optimized position and attitude data to form a pseudo-GPS signal, inputting the pseudo-GPS signal to the UAV for positioning, and performing route planning and setting landmark point tasks based on the current positioning.

12. The navigation and positioning method for UAV under GPS-DENIED conditions according to claim 11, further comprising:
integrating the measurements collected by the inertial sensor to obtain position, attitude and velocity of the UAV, integration formula is:
$$[ \begin{matrix}{α}_{{b}_{k + 1}}^{{b}_{k}} \\ {β}_{{b}_{k + 1}}^{{b}_{k}} \\ {γ}_{{b}_{k + 1}}^{{b}_{k}} \\ 0 \\ 0 \\ \end{matrix} ] = [ \begin{matrix}{R}_{w}^{{b}_{k}} ( {p}_{{b}_{k + 1}}^{w} - {p}_{{b}_{k}}^{w} + \frac{1}{2} {g}^{w} Δ {t}_{k}^{2} - {v}_{{b}_{k}}^{w} Δ {t}_{k} ) \\ {R}_{w}^{{b}_{k}} ( {v}_{{b}_{k + 1}}^{w} + {g}^{w} Δ {t}_{k} - {v}_{{b}_{k}}^{w} ) \\ {q}_{{b}_{k}}^{{w}^{- 1}} ⊗ {q}_{{b}_{k + 1}}^{w} \\ {b}_{{a}_{{b}_{k + 1}}} - {b}_{{a}_{{b}_{k}}} \\ {b}_{{w}_{{b}_{k + 1}}} - {b}_{{w}_{{b}_{k}}} \\ \end{matrix} ] ;$$
wherein, bₖ means the kth keyframe moment in IMU coordinate system, α_{b}_{ₖ₊₁}^{b}^{ₖ} indicates an amount of change in position between bₖ and bₖ₊₁ frame moment, β_{b}_{ₖ₊₁}^{b}^{ₖ} indicates an amount of change in velocity between bₖ and bₖ₊₁ frame moment, γ_{b}_{ₖ₊₁}^{b}^{ₖ} indicates an amount of change in attitude between bₖ and bₖ₊₁ frame moment, R_{w}^{b}^{ₖ} indicates a rotation from world coordinate system to the IMU coordinate system at bₖ frame moment, p_{b}_{ₖ₊₁}^{w} indicates a position of the world coordinate system at bₖ₊₁ frame moment, p_{b}_{ₖ}^{w} indicates a position of the world coordinate system at bₖ frame moment, g^{w} indicates an acceleration of gravity in the world coordinate system, Δtₖ indicates a time interval from bₖ frame moment to bₖ₊₁ frame moment, v_{b}_{ₖ}^{w} indicates a velocity in the world coordinate system at bₖ frame moment, v_{b}_{ₖ₊₁}^{w} indicates a velocity in the world coordinate system at bₖ₊₁ frame moment, q_{b}_{ₖ}^{w} indicates an attitude in the world coordinate system at bₖ frame moment, q_{b}_{ₖ₊₁}^{w} indicates an attitude in the world coordinate system at bₖ₊₁ frame moment,
$${b}_{{a}_{{b}_{k + 1}}}$$
indicates a bias of IMU accelerometer at bₖ₊₁ frame moment,
$${b}_{{a}_{{b}_{k}}}$$
indicates a bias of IMU accelerometer at bₖ frame moment,
$${b}_{{w}_{{b}_{k + 1}}}$$
indicates a bias of IMU gyroscope at bₖ₊₁ frame moment, and
$${b}_{{w}_{{b}_{k}}}$$
indicates a bias of IMU gyroscope at bₖ frame moment.

13. The navigation and positioning method for UAV under GPS-DENIED conditions according to claim 12, further comprising:
obtaining state variables in the sliding-window, the state variables comprising:
position of IMU coordinate system, velocity, attitude, accelerometer bias, gyroscope bias, external parameter from camera to IMU, inverse depths of the m+1 3D landmark points during n+1 keyframe moments within sliding-window;
wherein, state variables to be solved are expressed as:
$$\begin{matrix}χ = [ {x}_{0} , {x}_{1} , … {x}_{n} , {λ}_{0} , {λ}_{1} , … {λ}_{m} ] \\ {x}_{k} = [ {p}_{{b}_{k}}^{w} , {v}_{{b}_{k}}^{w} , {q}_{{b}_{k}}^{w} , {b}_{a} , {b}_{g} ] , k ∈ [ 0 , n ] \\ {x}_{c}^{b} = [ {p}_{c}^{b} , {q}_{c}^{b} ]\end{matrix} ;$$
wherein, X denotes a set of state variables to be optimized during n+1 keyframe moments and m+1 landmark points, xₖ denotes a set of position p_{b}_{ₖ}, velocity v_{b}_{ₖ}, attitude q_{b}_{ₖ}, bias bₐ of the IMU accelerometer and bias b_{g} of the IMU gyroscope in the world coordinate system at bₖ frame moment, x_{c}^{b} denotes a translation p_{c}^{b} and a rotation q_{c}^{b} from a camera coordinate system to the IMU coordinate system.

14. The navigation and positioning method for UAV under GPS-DENIED conditions according to claim 13, wherein graph optimization cost function is:
$${min}_{χ} \{ {‖ {r}_{p} - {H}_{p} χ ‖}^{2} + {\sum }_{k ∈ B} {‖ {r}_{B} ( {𝓏}_{{b}_{k + 1}}^{{b}_{k}} , χ ) ‖}_{{p}_{{b}_{k + 1}}^{{b}_{k}}}^{2} + {\sum }_{( f , j ) ∈ 𝒞} {‖ {r}_{C} ( {𝓏}_{f}^{{c}_{j}} , χ ) ‖}_{{p}_{f}^{{c}_{j}}}^{2} + {\sum }_{( l , v ) ∈ L} {‖ {r}_{L} ( {𝓏}_{l}^{{c}_{v}} , χ ) ‖}_{{p}_{l}^{{c}_{v}}}^{2} \} ;$$
wherein, rₚ denotes a marginalized priori error, Hₚ denotes a Hessian matrix, B denotes a set of IMU measurements, z_{b}_{ₖ₊₁}^{b}^{ₖ} denotes measurements of IMU between bₖ and bₖ₊₁ frame moment, p_{b}_{ₖ₊₁}^{b}^{ₖ} denotes a position from bₖ to bₖ₊₁ frame moment, r_{B} denotes a errors in pre-integration, C denotes a set of point features, z_{f}^{c}^{ⱼ} denotes an observation value at fth point feature of cⱼth image, p_{f}^{c}^{ⱼ} denotes a position of fth point feature of cⱼth image, r_{c} denotes a reprojection error of point features, L denotes a set of line features, zₗ^{c}^{ᵥ} denotes an observation value at lth line feature of cᵥth image, pₗ^{c}^{ᵥ} denotes a position of lth line feature of cᵥth image, r_{L} denotes a reprojection error of line features.

15. The navigation and positioning method for UAV under GPS-DENIED conditions according to claim 11, wherein the parallax of the binocular camera is a difference in orientation between two cameras of the binocular camera observing a same target, and an angle between the two cameras as viewed from the target indicates a parallax angle of the two cameras, and a line connecting the two cameras is the baseline.

16. The navigation and positioning method for UAV under GPS-DENIED conditions according to claim 11, wherein the position and attitude of camera is used for UAV navigation, and the depth of landmark point is used to build a map of the environment.

17. The navigation and positioning method for UAV under GPS-DENIED conditions according to claim 12, wherein the fusing measurement data of the inertial sensor and the binocular camera comprises:
fusing position, attitude and velocity obtained by integration of the inertial sensor, features extracted by the binocular camera, and image features matched by the binocular camera, to obtain optimized position, attitude and velocity.

18. A navigation and positioning system for an unmanned aerial vehicle (UAV) under GPS-DENIED conditions, comprising:
a data obtaining module, configured to obtain measurements of an inertial sensor and an image of a binocular camera, extract and track point features of the image, and obtain an altitude value measured by a ranging radar;
a data calculating module, configured to initialize a binocular camera, and calculate a position and attitude of camera and a depth of the landmark point based on a parallax and a baseline of the binocular camera;
a fusing and optimal module, configured to fuse measurement data of the inertial sensor and the binocular camera, use sliding-window based nonlinear graph optimization to obtain high-precision position and attitude data;
an optimal position and attitude module, configured to obtain the altitude value of the ranging radar and perform four-degree-of-freedom position and attitude graph optimization after adding detected keyframes when a loopback detection module detects a repeated occurrence of the UAV at the same location; and
a navigation and positioning module, configured to encapsulate optimized position and attitude data to form a pseudo-GPS signal, input the pseudo-GPS signal to the UAV for positioning, and perform route planning and set landmark point tasks based on the current positioning.

19. An unmanned aerial vehicle (UAV), comprising: a memory, a processor and a navigation and positioning program for UAV under GPS-DENIED conditions stored on the memory and runnable on the processor, the highly reliable and high-precision navigation and positioning program for UAV under GPS-DENIED conditions, when being executed by the processor, implements the steps of the highly reliable and high-precision navigation and positioning method for UAV under GPS-DENIED conditions according to claim 11.
